(19) United States
(12) Patent Application Publication
(10) Pub. No.: US 2013/0062887 A1
(43) Pub. Date: Mar. 14, 2013

(54) Gravito-electric power generation

(71) Applicant: Roger Ellman, Santa Rosa, CA (US)

(72) Inventor: Roger Ellman, Santa Rosa, CA (US)

(21) Appl. No.: 13/199,867

(22) Filed: Sep. 13, 2011

(51) Int. Cl. H02K 7/18; F03G 7/10

(52) U.S. Cl. 290/1 R; 74/DIG. 9

(57) ABSTRACT

This disclosure presents and claims means for the modification of local gravitation by modifying its direction of action and presents and claims various uses of those means. The new technology involved is the recognition that light and gravitation flow in the same common medium; that the observed effects of gravitational lensing and light diffraction demonstrate the gravitational field of atoms deflecting the flow of that common medium of light and gravitation; that a suitable arrangement of atoms consequently could produce a desired deflection of gravitation; and that the atomic structure of a cubic crystal [for example Silicon] is suitable for that application.

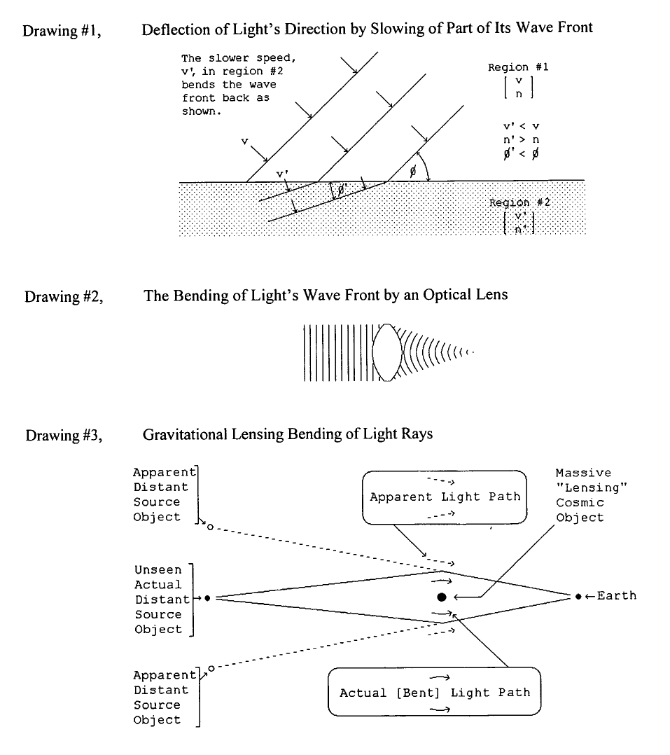

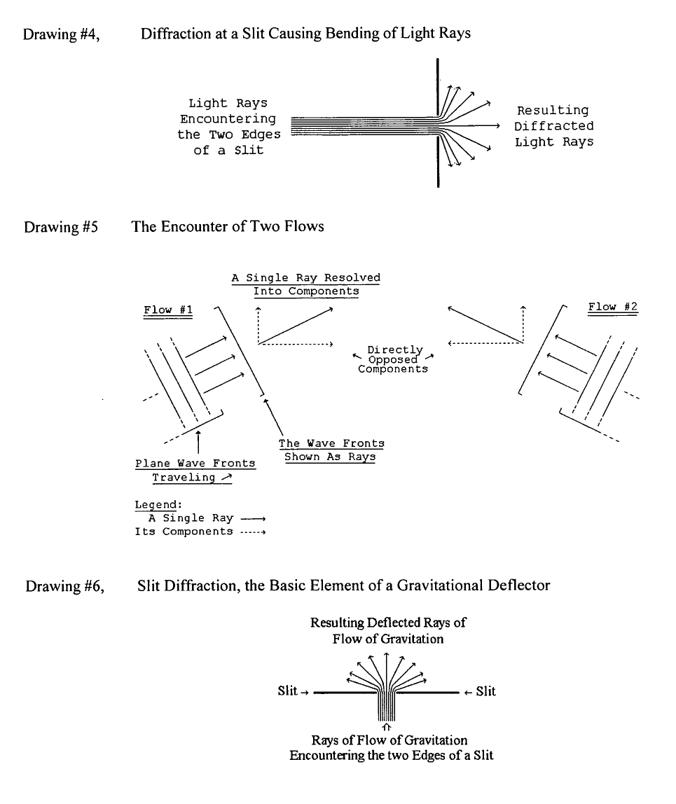

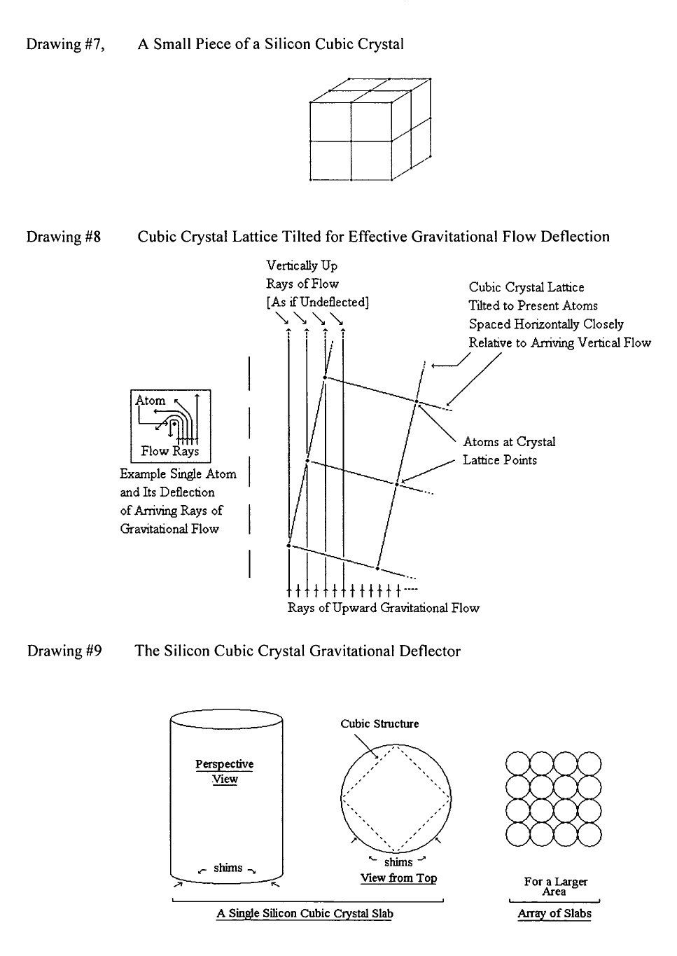

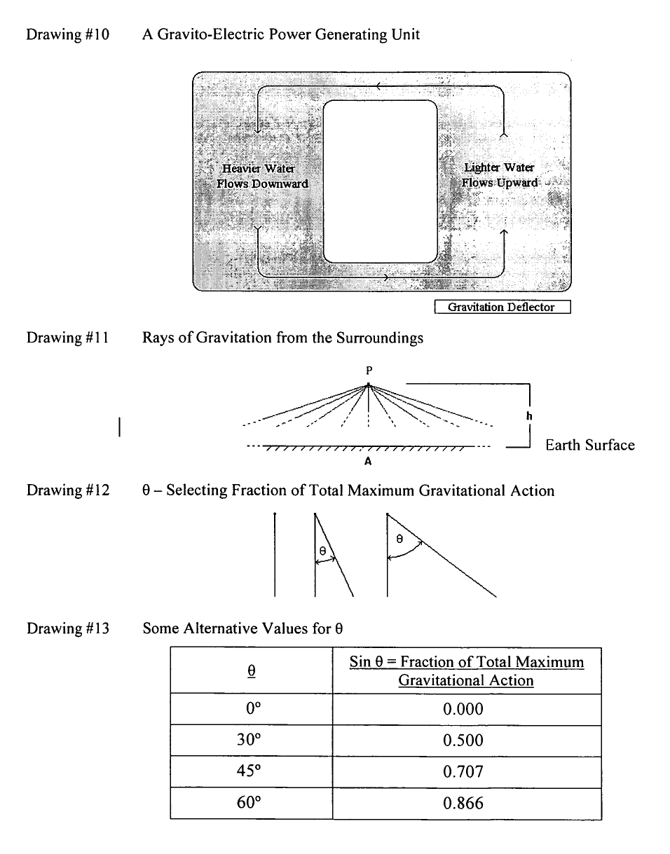

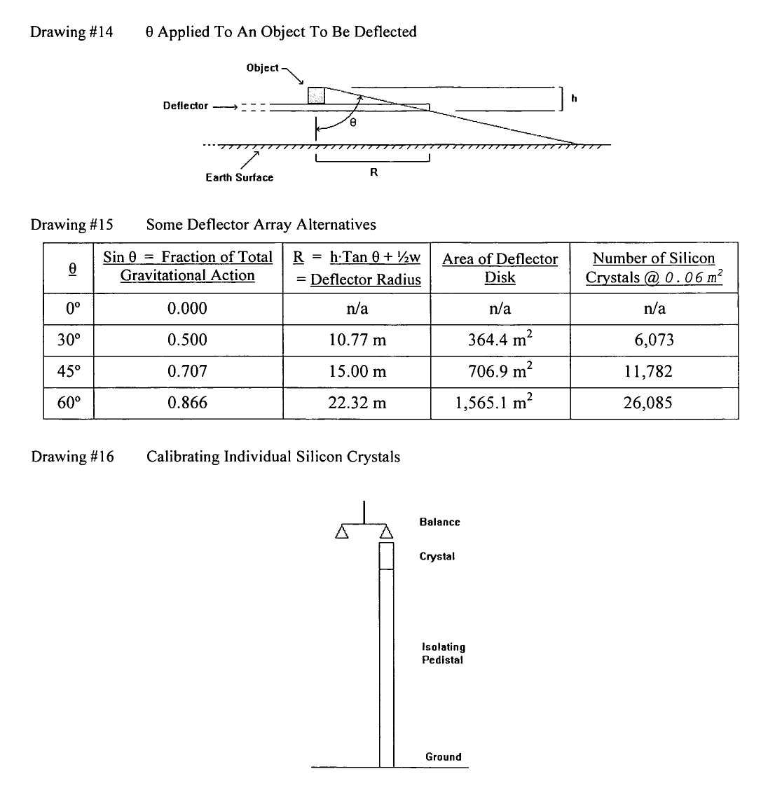

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### INDEX TO PAGE NUMBERS OF ALL FOLLOWING PARAGRAPHS

| Paragraph Title | Paragraph Nr. | Page Nr. |
|---|---|---|
| BACKGROUND OF THE INVENTION | [0004] | 2 |
| SUMMARY DEVELOPMENT | [0005] | 2 |
| ELECTRO-MAGNETIC FIELD (LIGHT) | [0006] | 3 |
| AND GRAVITATIONAL FIELD (GRAVITY) | | |
| GRAVITATIONAL SLOWING/DEFLECTION | [0007] | 4 |
| OF LIGHT | | |
| THE ENERGY ASPECT AND THE SOURCE | [0008] | 5 |
| OF THE FLOW | | |
| TAPPING THE ENERGY OF THE | [0009] | 6 |
| GRAVITATIONAL FIELD | | |
| BRIEF SUMMARY OF THE INVENTION | [0010] | 7 |
| BRIEF DESCRIPTION OF THE SEVERAL | [0011] | 8 |
| VIEWS OF THE DRAWING | | |
| DETAILED DESCRIPTION OF THE | [0012] | 9 |
| INVENTION | | |
| CLAIM OR CLAIMS | [0013] | 12 |
| ABSTRACT OF THE DISCLOSURE | [0014] | 13 |
| DRAWINGS (WHEN NECESSARY) | [0015] | 14 |
| OATH OR DECLARATION | [0016] | 18 |

### BACKGROUND OF THE INVENTION

### Introduction

It is now possible to deflect gravitational action away from an object so that the object is partially levitated. That effect makes it possible to extract energy from the gravitational field, which makes the generation of gravito-electric power technologically feasible.

Such plants would be similar to hydro-electric plants and would have their advantages of not needing fuel and not polluting the environment. However, gravito-electric plants could be much smaller than hydro-electric plants; their location would not be restricted to suitable water elevations, and the plants and their produced energy would be much less expensive.

With suitable design such plants could power all-electric: ships, aircraft, and land vehicles. Gravito-electric power can be made available now. It can replace existing nuclear and fossil fuel plants, and would essentially solve the problem of global warming to the extent it is caused by fossil fuel use.

### SUMMARY DEVELOPMENT

Light normally travels in a straight direction. But, when some effect slows a portion of the light wave front the direction of the light is deflected. In the figure, “Deflection of Light's Direction by Slowing of Part of Its Wave Front”, Drawing #1, the shaded area propagates the arriving light at a slower velocity, v′, than the original velocity, v, [its index of refraction, n′, is greater] so that the direction of the wave front is deflected from its original direction.

A slowing of part of its wave front is the mechanism of all bending or deflecting of light. In an optical lens, shown in the figure, “The Bending of Light's Wave Front by an Optical Lens”, Drawing #2, light propagates more slowly in the lens material than when outside the lens. The amount of slowing in different parts of the lens is set by the thickness of the lens at each part. In the figure the light passing through the center of the lens is slowed more than that passing near the edges of the lens. The result is the curving of the light wave front.

“Gravitational lensing”, shown in the figure “Gravitational Lensing Bending of Light Rays”, Drawing #3, is an astronomically observed effect in which light from a cosmic object too far distant to be directly observed from Earth becomes observable because a large cosmic mass [the “lens”], located between Earth observers and that distant object, deflects the light from the distant object as if focusing it, somewhat concentrating its light toward Earth enough for it to be observed from Earth. The light rays are so bent because the lensing object slows more the portion of the wave front that is nearer to it than it slows the farther away portion of the wave front.

The same effect occurs on a much smaller scale in the diffraction of light at the two edges of a slit cut in a flat thin piece of opaque material as shown in the figure, “Diffraction at a Slit Causing Bending of Light Rays”, Drawing #4. The bending is greater near the edges of the slit because the slowing is greater there. The effect of the denser material in which the slit is cut slows the portion of the wave front that is nearer to it more than the portion of the wave front in the middle of the slit.

In both of the cases, gravitational lensing and slit diffraction, the direction of the wave front is changed because part of the wave front is slowed relative to the rest of it. In the case of gravitational lensing the part of the wave front nearer to the “massive lensing cosmic object” is slowed more. In the case of diffraction at a slit the part of the wave front nearer to the solid, opaque material in which the slit is cut is slowed more.

But, neither of the cases, gravitational lensing and slit diffraction, involves the wave front passing from traveling through one substance to another as in the figure, “Deflection of Light's Direction by Slowing of Part of Its Wave Front”, Drawing #1. The wave front in the gravitational lensing case is traveling only through cosmic space. The wave front in the slit diffraction case is traveling only through air. There is no substance change to produce the slowing. What is it that slows part of the wave front thus producing the deflection ?

In the case of gravitational lensing the answer is that the effect is caused by gravitation. There is no other physical effect available. But how does gravitation produce slowing of part of the incoming wave front so as to deflect it ? Gravitation, at least as it is generally known and experienced, causes acceleration, not slowing.

Electro-Magnetic Field (Light) and Gravitational Field (Gravity)

### Light

Given two particles [e.g. electrons or protons] that have electric charges, the particles being separated and with the usual electric [Coulomb] force between them, if one of the charged particles is moved the change can produce no effect on the other charge until a time equal to the distance between them divided by the speed of light, c, has elapsed.

For that time delay to happen there must be something flowing from one charge to the other at speed c [a fundamental constant of the universe] and each charge must be the source of such a flow.

That electric effect is radially outward from each charge, therefore every charge must be propagating such a flow radially outward in all directions from itself, which flow must be the “electric field”.

When such a charge moves with varying speed it propagates a pattern called electromagnetic field outward into space. Light is that pattern, that field traveling in space. Since light's source is a charged particle that, whether the particle is moving or not, is continuously emitting its radially outward flow that carries the affect of its charge, then light's electromagnetic field is a pattern of variations in that flow due to the charge's varying speed.

### Gravity

Given two masses, i.e. particles [e.g. electrons or protons] that have mass, being separated and with the usual gravitational force [attraction] between them, if one of the masses is moved the change can produce no effect on the other mass until a time equal to the distance between them divided by the speed of light, c, has elapsed.

For that time delay to happen there must be something flowing from one mass to the other at speed c and each particle, each mass must be the source of such a flow.

That gravitational effect is radially outward from each mass, therefore every mass must be propagating such a flow radially outward in all directions from itself, which flow must be the “gravitational field”.

### That Flow

We therefore find that the fundamental particles of atoms, of matter, which have both electric charge and gravitational mass, must have something flowing outward continuously from them and:
Either the particles have two simultaneous, separate outward flows, one for the effects of electric charge and another for gravitation, or
They have one common universal outward flow that acts to produce all of the effects: electric and electromagnetic field [light] and gravitational field [gravity].

There is clearly no contest between the alternatives. It would be absurd for there to be two separate, but simultaneous, independent outward flows, for the two different purposes. And, the single universal outward flow from atoms, carrying both the electric and electromagnetic field and the gravitational field, means that gravitational field can have an affect on light, on electro-magnetic field because they both are the same medium—the universal outward flow.

The “gravitational lensing” presented earlier above is experimentally observed gravitational field affecting light.

### Gravitational Slowing/Deflection of Light

Because that universal outward flow originates at each particle and flows radially outward in all directions its density or concentration decreases inversely as the square of distance from the source of the flow. At a large distance from the source the wave front of a very small portion of the total spherical outward flow is essentially flat—a “plane flow”.

Two such universal flows directly encountering each other “head on” [flowing exactly toward each other] interfere with each other, that is each slows the flow of the other. The effect is proportional to the density or concentration of each flow.

When two such flows encounter each other but not directly “head on” then each flow can be analyzed into two components: one directly opposed to the other's flow and one at right angles to that direction per the figure “The Encounter of Two Flows”, Drawing #5

Picturing Flow #1 of that figure as that from a “lensing” gravitational mass and Flow #2 as that of the light from a distant object, then the figure depicts how the flow of the “lens” slows part of the wave front of the flow of the propagating light. The slowing is greater for rays of light that pass close to the lens and is less for those farther out because the density or concentration of the “lensing” gravitational mass's flow is less farther out. Thus the wave front of the light is deflected or bent as in the actually observed “gravitational lensing”.

In “gravitational lensing” gravitation produces deflection of the flow that carries light. That deflected flow is the same flow that also simultaneously carries gravitation. Thus the gravitational flow from one mass can produce deflection of the gravitational flow from another mass.

Therefore, a properly configured material structure can deflect gravitation away from its natural action, reducing the natural gravitation effect on objects that the gravitation would otherwise encounter and attract.

That same effect, on a vastly reduced scale, produces the deflection, the bending of the light direction that is seen in slit diffraction. In the diffraction effect the role of the “massive lensing cosmic object” is performed by the individual atoms making up the opaque thin material in which the slit is cut. That effect shows that the gravitational lensing process, involving immense cosmic masses, can be implemented on Earth on a much smaller scale practical for human use.

### The Energy Aspect and the Source of the Flow

But, changing the “natural gravitation effect” means changing the gravitational potential energy of objects in the changed gravitational field. If the energy is changed where does the difference come from or go to ?

The potential energy for an object of mass, m, at a height, h, in a gravitational field is truly potential. It is the kinetic energy that the mass would acquire from being accelerated in the gravitational field if it were to fall. The greater the mass, m, the greater the kinetic energy, ½·m·v². The greater the distance, h, through which the mass would fall the greater the time of the acceleration, the greater the velocity, v, achieved, the greater the kinetic energy, ½·m·v².

While at rest at height h [as on a shelf] the total mass of the object is the same as its rest mass. The object has no actual “potential energy”. It is merely in a situation where it could acquire energy, acquire it by falling in the gravitational field. Falling, the mass of the object increases as its velocity increases, reflecting its gradually acquired kinetic energy.

Since, until it falls, the object does not have the energy that it will acquire when it falls in the gravitational field the energy that it acquires must come from the gravitational field.

The energy of gravitational field is in its flow radially outward from all gravitational masses. The flow is a flow of the potential for energy, realized at any encounter with another gravitational mass
That flow creates potential energy, creates the situation where kinetic energy could be acquired, at any gravitational mass that it encounters.
It does so continuously, replenished and replenishing by the on-going continuing flow.
It does so continuously, regardless of the number or amount of masses encountered and regardless of their distance from the source of the flow.
At each encountered mass the amount of the flow varies with the magnitude of its source mass and varies inversely as the square of the distance from it.

But, for the flow to be a movement of something away from the source mass, the source mass must be a supply, a reservoir, of what is flowing so as to supply the flow. The original supply of the flow, of gravitational potential energy, came into existence at the “Big Bang” beginning of the universe.

If that immense reservoir of energy could be tapped by tapping some of its appearance in its outward flow, which is the gravitational field, it could supply all of civilization's energy needs cheaply, cleanly, and permanently without [for practical human/Earth purposes] being used up.

Since the original “Big Bang” the outward flow has been very gradually depleting the original supply. That process, an original quantity gradually depleted by flow away of some of the original quantity is an exponential decay process and the rate of the decay is governed by its time constant. In the case of the overall universal decay, appearing among other places in the outward flow from every gravitating mass, the time constant is about τ=3.57532·10¹⁷ sec (≈11.3373·10⁹ years).

### Tapping the Energy of the Gravitational Field

That outward flow of gravitational energy can be tapped, that is a portion of it can be extracted, by deflecting part of a small local region's gravitation so as to produce an imbalance in a rotary device above it [analogously to a water wheel], which device, connected to an electric generator, generates electrical energy, useful electric power. The figure “Slit Diffraction, the Basic Element of a Gravitational Deflector”, Drawing #6 [the slit diffraction figure from earlier above but now rotated 90°] illustrates such deflection using a single slit.

Multiple such slits parallel to each other would spread the deflection left and right in the figure. Additional multiple such slits at right angles to the first ones would spread the deflection over a significant area.

### BRIEF SUMMARY OF THE INVENTION

The invention consists of:

[1] A “Gravitic Deflector” using arrangements of atoms, that is configurations of atoms in a piece of material and the orientation of the material relative to the gravitational field, such that for at and near one particular direction through that material the atoms are effectively so spaced, that is located, that all gravitational field acting through the material in that particular direction must pass so close to some atom in the material that the path of propagation of that gravitational field is deflected away from things on the side of the material opposite from that side at which the gravitational field first entered the material with the result that any object or objects on that far side of the material experience less gravitational action than they would otherwise have experienced;

[2] Useful applications of those effects including generation of electric power and creation of reduced gravitation environments for experiments, manufacture, and entertainment.

### BRIEF DESCRIPTION OF THE SEVERAL VIEWS OF THE DRAWING

Drawing #1, Deflection of Light's Direction by Slowing of Part of Its Wave Front

Drawing #2, The Bending of Light's Wave Front by an Optical Lens

Drawing #3, Gravitational Lensing Bending of Light Rays

Drawing #4, Diffraction at a Slit Causing Bending of Light Rays

Drawing #5 The Encounter of Two Flows

Drawing #6, Slit Diffraction, the Basic Element of a Gravitational Deflector

Drawing #7, A Small Piece of a Silicon Cubic Crystal

Drawing #8 Cubic Crystal Lattice Tilted for Effective Gravitational Flow Deflection

Drawing #9 The Silicon Cubic Crystal Gravitational Deflector

Drawing #10 A Gravito-Electric Power Generating Unit

### DETAILED DESCRIPTION OF THE INVENTION

The general vertically upward outward flow of gravitational energy can be tapped by deflecting part of a local region's gravitational flow away from its normal vertical direction. That produces above that local region a region of lesser gravitation than its surroundings of normal gravitation. That can be configured to produce an imbalance in a rotary device above it powering its rotation analogously to a water wheel. That rotational energy, connected to an electric generator, can generate electrical energy, i.e. useful electric power. The figure “Slit Diffraction, the Basic Element of a Gravitational Deflector”, Drawing #6 illustrates with a single slit the deflection away from the vertical of incoming vertically upward flow.

Multiple such slits parallel to each other would spread the deflection left and right in the figure. Additional multiple such slits at right angles to the first ones would spread the deflection over a significant area.

The edges of the slit in the figure of Drawing #6, are actually rows of atoms. A cubic crystal, such as of Silicon, consists of such rows of atoms, multiple rows and rows at right angles, all equally spaced as shown in the figure “A Small Piece of a Silicon Cubic Crystal”, Drawing #7. It is a naturally occurring configuration of the set of slits required for deflection of gravitation.

The flow from each of the cubic crystal's atoms is radially outward. Therefore its concentration falls off as the square of distance from the atom. The amount of slowing of an incoming gravitational flow and therefore the amount of its resulting deflection, depends on the relative concentration of the atoms' flow and the overall gravitational flow.

In the case of diffraction of the flow of light at a slit as in Drawing #4, “Diffraction at a Slit Causing Bending of Light Rays”, the concentration of the flow from the atoms of the slit material is comparable to the concentration in the horizontal flow of the light, because it originates from a local source, not from the Earth's immense gravitation.

But for the flow from the atoms of the slit to deflect the immensely more concentrated vertically upward flow of Earth's gravitation the flow from the atoms of the slit must also be much more concentrated. The only way to achieve that more concentrated flow is to create a configuration in which the flow of Earth's gravitation is forced to pass much closer to the atoms of the slit so that, per the inverse square variation in the atoms' flow, it will pass through a concentration of the slit atom's flow comparable to the concentration in the Earth's gravitational flow.

The spacing between the edges of the diffracting slit of Drawing #6, “Slit Diffraction, the Basic Element of a Gravitational Deflector” is about 5·10⁻⁶ meters. The spacing of the atoms at the corners of the “cubes” in a Silicon cubic crystal, Drawing #7 is 5.4·10⁻¹⁰ meters. An inter-atomic spacing of less than 3·10⁻¹⁹ meters, much closer than the natural spacing in the Silicon cubic crystal, is required to obtain deflection of a major portion of the incoming Earth's gravitational flow.

Such a close atomic spacing does not naturally occur nor can it be directly produced in any material. However, that close an atomic spacing can be effectively produced relative to just the vertical flow of gravitation by slightly tilting the Silicon cubic crystal's cubic structure relative to the vertical as illustrated schematically and not to scale in The figure “Cubic Crystal Lattice Tilted for Effective Gravitational Flow Deflection”, Drawing #8.

By appropriate tilting of the cubic structure each of its 5.4·10⁻¹⁰ meters inter-atomic spaces is effectively sub-divided into 10¹⁰ “sub-spaces” each of them 5.4·10⁻²⁰ meters long and with an atom in each. A 4.5 mm shim on a 30 cm diameter Silicon cubic crystal slab produces such an effect, producing a tilt tangent=0.015 for a tilt angle=0.86° that produces the objective effective sub-division of the crystals' natural inter-atomic spacing, a sub-division that acts only on vertical flow, as of gravitation.

Pure, monolithic, Silicon cubic crystals up to 30 cm in diameter are grown for making the “chips” used in many electronic devices. The gravitational deflector requires a large, thick piece of Silicon cubic crystal rather than the thin wafers sawed from the “mother” crystal for “chip” making.

The Silicon cubic crystal slab for the deflector is to be:
30 cm in diameter,
49 cm or more thick,
with the orientation of the cubic structure marked for proper placement of tilt-generating shims, and
with the bottom face of the cylinder sawed and polished flat at a single cubic structure plane of atoms.

Mean free path [MFP] is the average straight line distance a moving particle travels between encounters with another particle. For atoms in solid matter the mean free path is

$$M F P = \frac{1}{[ Atoms Per Unit Volume ] \cdot [ Atom Cross Section Area ]}$$

For the Earth the atoms per unit volume is on the order of

Atoms per Unit Volume=5·10²⁸ per cubic meter.

In the cubic crystal deflector the atom spacing achieved by the tilt is 10⁻²⁰ meters. Each therefore has cross sectional space available to it equal to a circle of that diameter so that for this purpose the atom's cross section area is

$$\begin{matrix}Atom Cross Section Area = π / 4 \cdot {[ {10}^{- 20} ]}^{2} \\ = 8 \cdot {10}^{- 39} {meter}^{2}\end{matrix}$$

For targets as fine as those in the cubic crystal deflector, the mean free path in the Earth's outer layers is, therefore

MFP=2.5·10⁹ meters

The mean free path in the 49 cm thick minutely tilted Silicon cubic crystal slab for intercepting Earth's natural vertically outward gravitation is ½ the 49 cm thickness of the slab. The gravitational deflector is about 10¹⁰ times more effective than the natural Earth at intercepting Earth's natural gravitation

However, that effectiveness is only for vertical rays of flow, which are the only rays the deflection of which is desired—rays of flow of Earth's outward, vertically upward gravitational flow.

The Silicon crystal's mean free path for non-vertical flow—such as flow already once deflected within the crystal—is that of Earth, 2.5·10⁹ meters, which causes the once-deflected flow to pass out of the crystal.

The overall deflector consists of the following:
A support having a verified perfectly horizontal upper surface for the cubic crystal deflector bottom face to rest upon;
The Silicon cubic crystal slab specified above
Precision shims 4.5 mm thick for producing the tilt of the cubic crystal slab, the shims located at the mid-point of two adjacent sides of the horizontal plane of the cubic structure.
All as in the figure “The Silicon Cubic Crystal Gravitational Deflector”, Drawing #9

Application of the Silicon Cubic Crystal Gravitational Deflector for the purpose of generating electric power, a gravito-electric power generating unit, is depicted in the figure “A Gravito-Electric Power Generating Unit”, Drawing #10.

The concept is analogous to hydro-electric power generation, but instead of needing the Sun to provide, by means of evaporation and rain fall, an elevated supply of water to fall in the gravitational, field this gravito-electric power generator directly taps the energy supply of the flowing gravitational field.

1. The use of arrangements of atoms, that is configurations of atoms in a piece of material and the orientation of the material relative to the gravitational field, such that for at and near one particular direction through that material the atoms are effectively so spaced, that is located, that all gravitational field acting through the material in that particular direction must pass so close to some atom in the material that the path of propagation of that gravitational field is deflected away from things on the side of the material opposite from that side at which the gravitational field first entered the material with the result that any object or objects on that far side of the material experience less gravitational action than they would otherwise have experienced.

2. Such use of arrangements of atoms for electric power generation.

3. Such use of arrangements of atoms for reduced gravitation/reduced weight environments.
